(19) United States
(12) Patent Application Publication
(10) Pub. No.: US 2012/0212967 A1
(43) Pub. Date: Aug. 23, 2012

(54) ILLUMINATION UNIT FOR CHARGING CONNECTOR

(75) Inventor: Masahiro SAWAYANAGI, Shizuoka (JP)

(73) Assignee: YAZAKI CORPORATION, Tokyo (JP)

(21) Appl. No.: 13/398,886

(22) Filed: Feb. 17, 2012

(30) Foreign Application Priority Data
Feb. 21, 2011 (JP) 2011-034114

(51) Int. Cl. F21V 33/00

(52) U.S. Cl. 362/362

(57) ABSTRACT

An illumination unit for a charging connector is provided. The charging connector includes a power supply connector and a power receiving connector. The illumination unit is configured to be arranged on a periphery of the power receiving connector. A light-transmitting housing contains the light source. A non-light-transmitting cover detachably covers a light-transmitting portion of the light-transmitting housing. The non-light-transmitting cover is formed with a light-through window for passing a light from the light source therethrough.

The disclosure of Japanese Patent Application No. 2011-034114 filed on Feb. 21, 2011, including specification, drawings and claims is incorporated herein by reference in its entirety.

### BACKGROUND

The present invention relates to an illumination unit for a charging connector.

In electrical vehicles or hybrid vehicles, a charging connector including a power supply connector and a power receiving connector (a vehicle-side inlet) is used to charge a battery therein.

In Patent Document 1 as described below, a technology relation to a charging connector is described. According to such a technology, a power receiving connector is provided in a power receiving side chamber arranged in a vehicle. The power receiving side chamber is also provided with a lamp. The lamp is a component for constituting an illumination unit and adapted to turn on or off, when an opening/closing lid of the power receiving side chamber is opened or closed. The lamp is provided to easily perform an operation for coupling or decoupling a power supply connector and a power receiving connector to each other in the night. The lamp is provided in the power receiving side chamber in an exposed and projected state.
Patent Document 1 JP-A-6-325834

In such a related-art, when coupling or decoupling the power supply connector and the power receiving connector, there is a problem in which the power supply connector can be collided with the exposed and projected lamp by mistake. If the power supply connector is collided with the lamp such that the lamp is broken, a situation in which the illumination unit has to be replaced as a whole can be possibly occurred. When the whole of the illumination unit is replaced or the lamp is replaced, increases of costs can be caused.

However, if the power receiving side chamber is provided with a decorative cover, and openings are formed to extend through predetermined positions on the decorative cover such that the power receiving connector and the lamp are respectively projected through the openings, the following problem is caused to the decorative cover and the lamp. Namely, when the opening for the lamp is formed very larger than an external shape of the lamp in consideration of a misalignment and the like, it is inevitable to create a gap therebetween degrading an external appearance.

In addition, when the illumination unit including the lamp is deployed in different vehicles, there is also a problem. Namely, if vehicles are different from each other, illumination ranges thereof can be also different such that the illumination unit cannot be deployed. When the illumination unit cannot be deployed, it is inevitable to manufacture a new illumination unit, and thus a universality of the illumination unit is poor.

### SUMMARY

It is therefore an object of the present invention to provide an illumination unit for a charging connector in which a durability, an universality and an external appearance can be enhanced and increases of costs can be inhibited.

According to an aspect of the embodiments of the present invention, there is provided an illumination unit for a charging connector including a power supply connector and a power receiving connector, the illumination unit configured to be arranged on a periphery of the power receiving connector, the illumination unit comprising: a light source; a light-transmitting housing that contains the light source; a non-light-transmitting cover that detachably covers a light-transmitting portion of the light-transmitting housing, wherein the non-light-transmitting cover is formed with a light-through window for passing a light from the light source therethrough.

With this configuration, the light source is covered with the light-transmitting housing, and in turn, the light-transmitting housing is covered with the detachable non-light-transmitting cover. The light from the light source is transmitted through the light-transmitting portion of the light-transmitting housing and then pass through the light-through window of the non-light-transmitting cover to be irradiated on the power receiving connector. Accordingly, even when the power supply connector is collided with the non-light-transmitting cover to cause a flaw or breakage on the non-light-transmitting cover, the non-light-transmitting cover only needs to be replaced. Also, according to the aspect of the embodiments of the present invention, the light source is covered with the non-light-transmitting cover, such that a structure difficult to be broken can be established. Furthermore, according to the aspect of the embodiments of the present invention, when a plurality of non-light-transmitting covers formed by varying an opening area of the light-through window are prepared, the deployment of the illumination unit can be established by only replacing the non-light-transmitting covers even in vehicles having different illumination ranges. Therefore, according to the aspect of the embodiments of the present invention, the replacement of the whole of the illumination unit is not caused, and as a result, the increases of costs can be inhibited.

Accordingly, the illumination unit for the charging connector is provided in which the light source is covered with the light-transmitting housing, and in turn, the light-transmitting housing is covered with the detachable non-light-transmitting cover having the light-through window. Therefore, the durability and the universality of the illumination unit can be enhanced. In addition, the increases of costs can be inhibited.

The light source may comprise at least one of an LED, a lamp, and a light-emitting indicator.

With this configuration, an LED or a lamp is employed as the light sources, or a light-emitting indicator is employed as the light sources to indicate a charging state. According to the aspect of the embodiment of the present invention, other light sources may be employed in accordance with specifications. According to the aspect of the embodiments of the present invention, the LED and the light-emitting indicator may be employed together.

Accordingly, better types of the light source constituting the illumination unit for the charging connector can be provided.

An inside of the non-light-transmitting cover or an outside of the light-transmitting housing may be integrally or separately provided with an elastic contact portion.

With this configuration, a misalignment and the like can be absorbed by an elastic deformation amount of the elastic contact portion. Such an elastic deformation of the elastic contact portion can align the light-transmitting housing inside the non-light-transmitting cover when the light-transmitting housing covers the light source. According to the aspect of the embodiments of the present invention, even when colliding with the power supply connector, an impact force can be absorbed by an elastic force of the elastic contact portion, and as a result, a breakage can be prevented or reduced.

Accordingly, by providing the elastic contact portion, the durability can be further enhanced, and the external appearance can be also enhanced.

The non-light-transmitting cover may be formed as an elastic body.

With this configuration, the misalignment and the like can be absorbed by an elastic deformation amount of the non-light-transmitting cover as the elastic body. Such an elastic deformation of the non-light-transmitting cover can align the light-transmitting housing when the light-transmitting housing covers the light source. According to the aspect of the embodiments of the present invention, even when colliding with the power supply connector, an impact force can be absorbed by an elastic force of the non-light-transmitting cover, and as a result, a breakage can be prevented or reduced. According to the aspect of the embodiments of the present invention, the non-light-transmitting cover is preferably made of an elastomeric material having a flexibility and an elasticity, such as a rubber.

Accordingly, by forming the non-light-transmitting cover itself as the elastic body, the durability can be further enhanced, and the external appearance can be also enhanced.

The above-described configurations are effective in a case in which a decorative cover is provided on a power receiving side chamber. Therefore, the misalignment and the like can be absorbed by the elastic deformation in the illumination unit without forming a large opening on the decorative cover. The decorative corer can be provided with an opening having a size suitable to prevent a gap from being created.

### BRIEF DESCRIPTION OF THE DRAWINGS

In the accompanying drawings:

FIGS. 1A and 1B are views illustrating an illumination unit for a charging connector according to an embodiment of the present invention, wherein FIG. 1A is a view illustrating an arrangement of the illumination unit and a power receiving connector in a power receiving side chamber, and FIG. 1B is a cross-sectional view illustrating an aligning device of the illumination unit;

FIG. 2 is a cross-sectional view of the illumination unit;

FIG. 3 is a perspective view of the illumination unit; and

FIG. 4 is a cross-sectional view illustrating an illumination unit for a charging connector according to another embodiment of the present invention.

### DETAILED DESCRIPTION OF THE EMBODIMENTS

An illumination unit for a charging connector includes a portion for irradiating light toward a power receiving connector, constituted in the following manner. Namely, a light source is covered with a light-transmitting housing, and the light-transmitting housing is additionally covered with a detachable non-light-transmitting cover having a light-through window.

### Embodiment 1

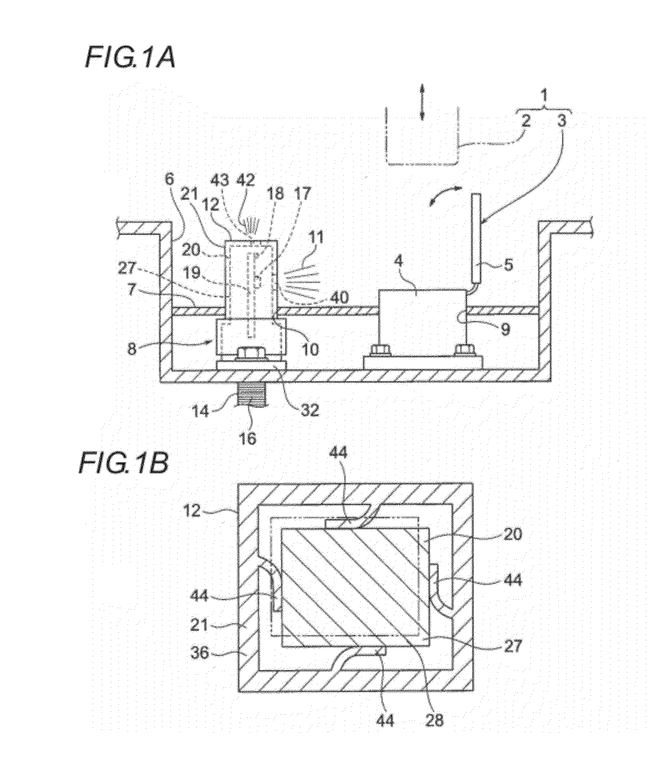

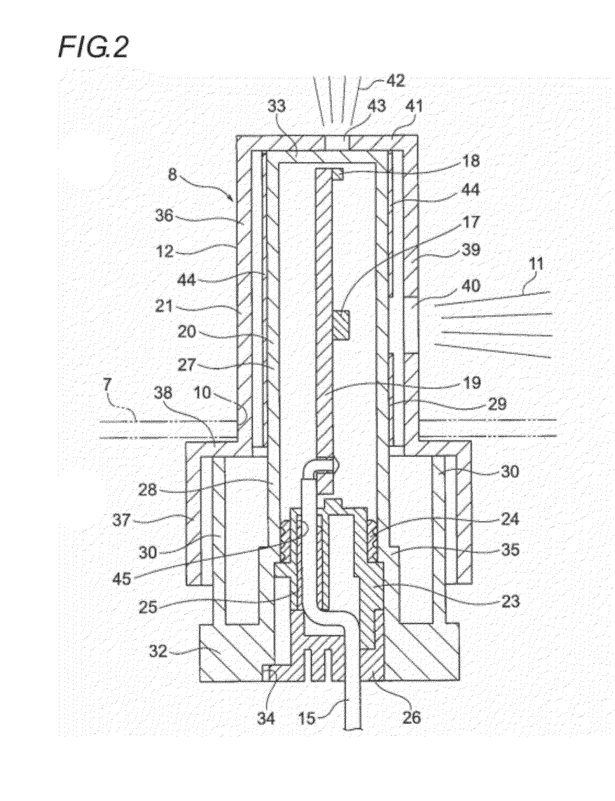

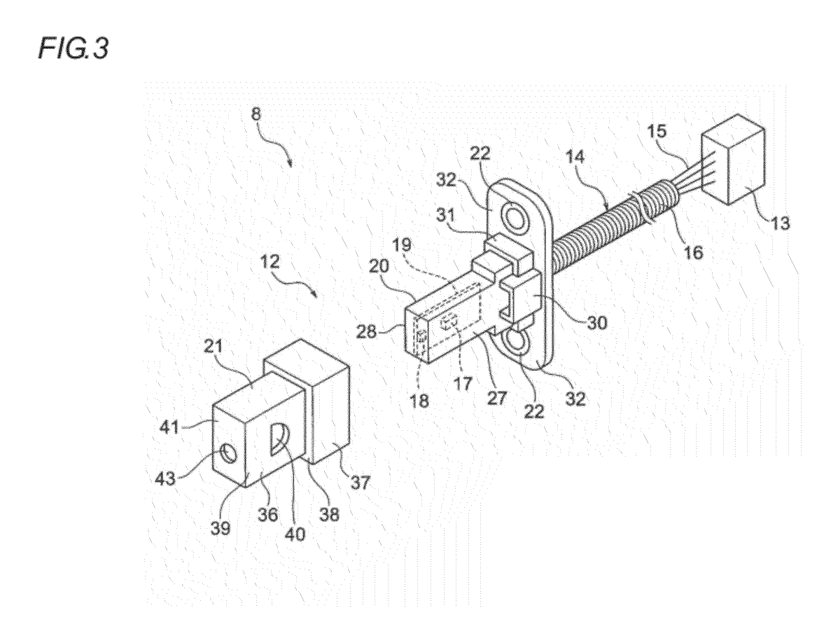

The embodiment 1 will be now described with reference to figures. FIGS. 1A and 1B are views illustrating an illumination unit for a charging connector according to an embodiment of the present invention, wherein FIG. 1A is a view illustrating an arrangement of the illumination unit and a power receiving connector in a power receiving side chamber, and FIG. 1B is a cross-sectional view illustrating an aligning device of the illumination unit. Also, FIG. 2 is a cross-sectional view of the illumination unit, and FIG. 3 is a perspective view of the illumination unit.

In the below description, specific shapes, materials, numeric values, directions and the like are intended to provide an example to easily understand the invention, and accordingly, can be properly modified according to uses, purposes, specifications and the like.

In electrical vehicles or hybrid vehicles, a high voltage battery is mounted to drive a motor. A charging connector is used to charge the battery (the charging connector in the description below may either be for direct current or for alternating current).

In FIG. 1A, the charging connector 1 includes a power supply connector 2 and a power receiving connector (a vehicle-side inlet) 3. The power supply connector 2 and the power receiving connector 3 are constructed to be coupled or decoupled to each other. The power receiving connector 3 has a charging port and a cap 5. The power receiving connector 3 is provided in a power receiving side chamber 6 disposed at a predetermined position on vehicles. In addition to the power receiving connector 3, the power receiving side chamber 6 additionally includes a decorative cover 7 and an illumination unit 8 (an illumination unit for the charging connector). The illumination unit 8 is provided to illuminate the power receiving connector 3 or to indicate a charging state by an emitted light.

The power supply connector 2 and the power receiving connector 3 may use those known in the art, and accordingly an explanation thereof will be omitted herein.

The decorative cover 7 is a plate-shaped member adapted to expose predetermined portions of the power receiving connector 4 and the illumination unit 8, and is attached to the power receiving side chamber 6 by fixing means. In the decorative cover 7, an opening 9 for the power receiving connector 3 and an opening 10 for the illumination unit 8 are formed. Each of the openings 9 and 10 is formed to be opened in predetermined sizes

Among the openings 9 and 10, at least the opening 10 is formed not to create a gap between the illumination unit 8 and the opening 10, if possible. With respect to the opening 8, an aligning device is provided on the illumination unit 8. The aligning device allows not to form a large opening for the illumination unit 8 in consideration of a misalignment and the like. A remarkably smaller gap than that of a related-art is created by the aligning device, and as a result, an external appearance can be enhanced.

The illumination unit 8 is adapted to irradiate a light 11 toward the power receiving connector 3 such that the power receiving connector 8 can be illuminated at a desired brightness. The illumination unit 8 is provided to easily perform an operation for coupling or decoupling the power supply connector 2 and the power receiving connector 3 to each other in the night or in a dark area. The illumination unit 8 according to the embodiment has, but not specially limited to, a timer function or a waterproof function.

In FIGS. 1A to 3, the illumination unit 8 includes a illumination function portion 12, a connector 13 (see FIG. 3) for connecting to a charging circuit (not shown) in vehicles, a harness 14 for electrically connecting the illumination function portion 12 with the connector 13, and a fixing mean (e.g., a known clip, but not shown) for properly securing the harness 14. The connector 13, the harness 14, and the fixing mean (not shown) use those known in the art. The harness 14 includes a plurality of wirings 15 and a corrugated tube 16 for protecting the plurality of wirings 15.

The illumination function portion 12 includes light sources, such as, an LED 17 and a light emitting indicator 18, a timer substrate assembly 19 for mounting the light sources, a light-transmitting housing 20, a non-light-transmitting cover 21, a collar 22, a holder 23, a packing 24, a rubber plug 25, and a holder cover 26.

The timer substrate assembly 19 has a rectangular substrate. The substrate is provided with a predetermined circuit for emitting the LED 17 and the light emitting indicator 18, a timer circuit, and the like. Conductors of the wirings 15 are electrically connected to connecting portions of the circuits by soldering and the like. The LED 15 is arranged to irradiate the light 11 toward the power receiving connector 3. Also, the light emitting indicator 18 is arranged to indicate a charging state by an emitted light. An illumination range of the light 11 by the LED 17 can be adjusted according to a shape of a light-through window 40, as described below, formed in the non-light-transmitting cover 21.

The light-transmitting housing 20 is molded using a light-transmitting synthetic resin material. In the embedment, the light-transmitting housing 20 is molded using the resin material to be transparent as a whole. Because the light-transmitting housing 20 is transparent as described above, the whole thereof is composed of a light-transmitting portion 27 through which the light can be transmitted.

The light-transmitting housing 20 has a housing main body 28 in which the timer substrate assembly 19 is contained and secured. The light-transmitting housing 20 has also projection portions 30 and 31 which project outwardly from on a side wall 29 of the housing main body 28. Additionally, the light-transmitting housing 20 has a securing portion 32 which forms a flange continued to the housing main body 28 and the projection portion 30 and 31.

The housing main body 28 is formed in a box shape having a rectangular cross-section. The housing main body 28 having such a shape has a top wall 33 at a top end in FIG. 3, and an opening 34 at a bottom end in FIG. 3. The opening 34 is arranged and formed such that an opened face thereof can be flushed with a lower surface of the securing portion 32. The housing main body 29 has a stepped portion 35 at the inside relative to the opening 34.

An inside surface of the stepped portion 35 is formed to serve as a stopper for determining an inserted extent of the holder 23. A portion located slightly upwardly from the stepped portion 35 is formed to serve as a seal surface to the packing 24.

The securing portion 32 is fixed to a bottom of the power receiving chamber 6 by bolting and has the collar 22 made of a metal.

The non-light-transmitting cover 21 is molded using a non-light-transmitting synthetic resin material. The non-light-transmitting cover 21 is formed in a shape which allows the light-transmitting housing 20 to be detachably covered. The non-light-transmitting cover 21 includes a first cover part 36 for covering the side wall 29 and the top wall 33 of the housing main body 28 of the light-transmitting housing 20, a second cover part 37 for covering the projection portion 30 and 31 of the housing main body 28, and a cover shoulder 38 for connecting the first cover part 36 with the second cover part 37.

A light-through window 40 is formed to extend through a side wall 39 of the first cover part 36 such that the light 11 from the LED 17 can pass therethrough. The light-through window 40 is arranged and formed corresponding to a location of the LED 17. Also, the light-through window 40 is formed in a shape considering the illumination range.

Meanwhile, when the illumination unit 8 is deployed in vehicles having different illumination ranges, a plurality of non-light-transmitting covers 21 formed by varying a shape of the light-through window 40 can be prepared to deal with such a situation. The reason is that such a deployment can be established by only replacing the non-light-transmitting covers 21.

A light-through window 43 is formed on top wall 31 of the first cover part 36 such that a light 42 from the light-emitting indicator 18 can pass therethrough. In the embodiment, the light-through window 43 is formed in a circular and extends through the top wall 31.

An inner surface of the side wall 39 of the first cover part 36 is integrally (or separately) provided with a plurality of elastic ribs 44 (elastic contact portions). The elastic ribs 44 are formed to be elastically deformed. The elastic ribs are adapted to align the light-transmitting housing 20 in a range of elastic deformation thereof. If a misalignment is caused relative to the opening 10 of the decorative 7, such a misalignment can be absorbed by elastic deformations of the plurality of elastic ribs 44 (see a phantom line in FIG. 1B).

Meanwhile, if the misalignment can be absorbed, an elastic body, such as a sponge and a rubber, instead of the elastic ribs 44, may be interposed between the inner surface of the side wall 39 and the light-transmitting housing 20. The elastic ribs 44 may be provided on the light-transmitting housing 20, not limited to the inner surface of the side wall 39.

The cover shoulder 38 is composed of a portion connecting between the first cover part 36 and the second cover part 38 as describe above. The cover shoulder 38 is effective to be not visible inside the decorative cover 7 through the opening 10.

The holder 23 is molded using an electric-insulating synthetic resin material. The holder 23 is adapted to insert in the housing main body 28 of the light-transmitting housing 20 in a state, in which the packing 24 is provided on an external peripheral surface thereof and the plurality of wirings 15 are inserted and extended therethrough.

The holder 23 includes electric wiring inserting through-holes 45 having a number corresponding to that of the wirings 15. The electric wiring inserting through-holes 45 are formed to water-tightly receive the wirings 15 to which the rubber plug 25 is attached.

The holder cover 26 is molded using an electric-insulating synthetic resin material. The holder cover 26 is formed to fit into the opening 34 of the housing main body 28. The holder cover 26 is formed to prevent the holder 23 from being detached.

The wirings 15 are retained by the holder 23 and the holder cover 25 with being bended into a generally crank shape as shown. Also, bending and retaining of the wirings 15 as described in the embodiment is intended to prevent an external force from being applied to connecting portions of the wirings 15 to the timer substrate assembly 19, even when the external force is applied to the wirings in a pulling direction.

In the configuration and construction as described above, the light 11 from the LED 17, as shown in FIG. 1A, is irradiated toward the power receiving connector 3 to brightly illuminate the power receiving connector 3, such that the operation for coupling or decoupling the power supply connector 2 and the power receiving connector 3 to each other can be easily performed. In addition, the light 42 from the light-emitting indicator 18 allows to identify whether charge is completed or not.

According to the embodiment of the present invention, as described above with reference to FIGS. 1A to 3, even when the power supply connector 2 is collided with the non-light-transmitting cover 21 to cause a flaw or breakage on the non-light-transmitting cover 21, the non-light-transmitting cover 21 only needs to be replaced. Also, according to the embodiment of the present invention, the LED 17 and the light-emitting indicator 18 are covered with the light-transmitting housing 20 or the non-light-transmitting cover 21, such that protection of the light sources as well as a structure difficult to be broken as a whole can be established. Furthermore, according to the embodiment of the present invention, when a plurality of non-light-transmitting covers 21 formed by varying an opening area of the light-through window 40 are prepared, the deployment of the illumination unit 8 can be established by only replacing the non-light-transmitting covers 21 even in vehicles having different illumination ranges. Therefore, according to the embodiment of the present invention, the replacement of the whole of the illumination unit 8 is not caused, and as a result, the increases of costs can be inhibited.

According to the embodiment of the present invention, the misalignment and the like can be absorbed by an elastic deformation amount of the elastic ribs 44. Such an elastic deformation of the elastic ribs 44 can align the light-transmitting housing 20 inside the non-light-transmitting cover 21. According the embodiment of the present invention, even when colliding with the power supply connector 2, an impact force can be absorbed by an elastic force of the elastic ribs 44, and as a result, a breakage can be prevented or reduced.

Such absorption of the misalignment and the like allows not to form a large opening on the decorative cover 7, and as a result, an external appearance thereof can be enhanced. In the non-light-transmitting cover 21, an external appearance of the cover shoulder 38 can be also enhanced.

### Embodiment 2

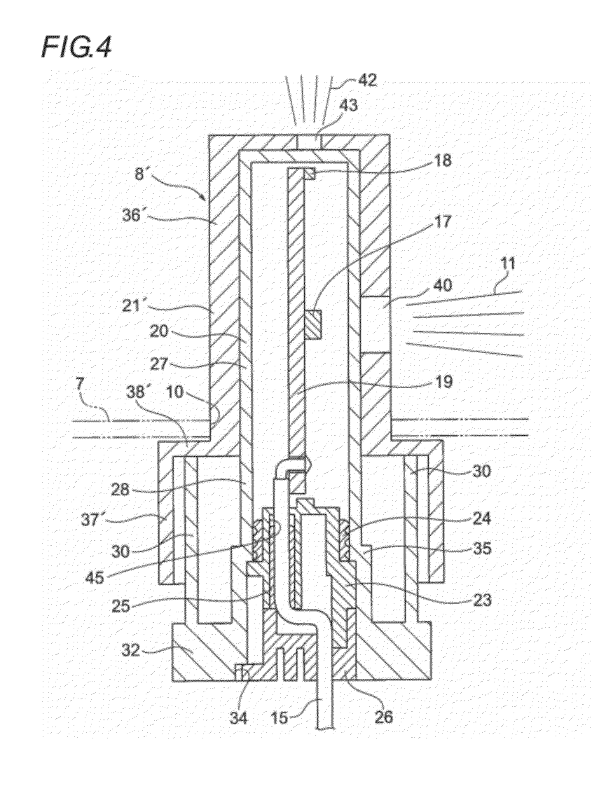

Hereafter, the embodiment 2 will be described with reference to FIG. 4. FIG. 4 is a cross-sectional view showing another embodiment of an illumination unit for a charging connector according to the embodiment of the present invention. Components identical to those of the embodiment 1 are denoted by identical reference numerals, omitting herein an explanation thereof.

In FIG. 4, an illumination unit 8′ includes a non-light-transmitting cover 21′ detachably attached to the light-transmitting housing 20. The non-light-transmitting cover 21′ only has a configuration different from those of the illumination unit 8 (see FIG. 2) according to the embodiment 1.

The non-light-transmitting cover 21′ is formed to constitute an elastic body as a whole (i.e., the non-light-transmitting cover 21′ is made of an elastomeric material having a flexibility and an elasticity, such as a rubber). The non-light-transmitting cover 21′ includes a first cover part 36′ having light-through windows 40 and 43, a second cover part 37′, and a cover shoulder 38′ for connecting the first cover part 36′ with the second cover part 37′. The first cover part 36′ is formed to cover the housing main body 28 of the light-transmitting housing 20 without a gap (this is only an example).

In the configuration and construction as described above, the non-light-transmitting cover 21′ can absorb the misalignment and the like by an elastic deformation amount thereof. Therefore, aligning of the light-transmitting housing 20 can be established. According the embodiment of the present invention, even when colliding with the power supply connector 2, an impact force can be absorbed by an elastic force of the non-light-transmitting cover 21′, and as a result, a breakage can be prevented or reduced.

In addition, various alternative embodiments can be made without departing from the sprit or scope of the invention.

What is claimed is:

1. An illumination unit for a charging connector including a power supply connector and a power receiving connector, the illumination unit configured to be arranged on a periphery of the power receiving connector, the illumination unit comprising:
a light source;
a light-transmitting housing that contains the light source;
a non-light-transmitting cover that detachably covers a light-transmitting portion of the light-transmitting housing,
wherein the non-light-transmitting cover is formed with a light-through window for passing a light from the light source therethrough.

2. The illumination unit according to claim 1, wherein the light source comprises at least one of an LED, a lamp, and a light-emitting indicator.

3. The illumination unit according to claim 1, wherein an inside of the non-light-transmitting cover or an outside of the light-transmitting housing is integrally or separately provided with an elastic contact portion.

4. The illumination unit according to claim 1, wherein the non-light-transmitting cover is formed as an elastic body.
